(19) United States
(12) Patent Application Publication
(10) Pub. No.: US 2023/0046387 A1
(43) Pub. Date: Feb. 16, 2023

(54) METHOD AND PLANT FOR PRODUCING HYDROGEN

(71) Applicant: Linde GmbH, Pullach (DE)

(72) Inventors: Andreas PESCHEL, Wolfratshausen (DE); Ute KOLLER, Bad Schönborn (DE); Steffen FAHR, Ratingen (DE)

(21) Appl. No.: 17/759,223

(22) PCT Filed: Nov. 19, 2020
(86) PCT No.: PCT/EP2020/025524

§ 371 Date: Jul. 21, 2022

(30) Foreign Application Priority Data
Jan. 27, 2020 (DE) 10 2020 000 476.8

(51) Int. Cl. C01B 3/48; B01J 19/24; C25B 1/042; C25B 15/08

(52) U.S. Cl. CPC C01B 3/48; B01J 19/245; C25B 1/042; C25B 15/081; C01B 2203/0233; C01B 2203/0283; C01B 2203/1241; C25B 1/23

(57) ABSTRACT

The invention relates to a method for producing hydrogen, in which, in a non-electrolytic method, a carbonaceous feed material is converted into non-electrolytically produced hydrogen and one or more further non-electrolytically produced products, and furthermore excess steam is provided using the non-electrolytic process. According to the invention at least a part of the excess steam is used at least intermittently to provide feed steam, which is converted by means of steam electrolysis to electrolytic hydrogen and electrolytic oxygen. The present invention also relates to a corresponding plant.

The invention relates to a method for producing hydrogen and to a corresponding plant in accordance with the respective preambles of the independent claims.

### PRIOR ART

A number of different methods for producing hydrogen on an industrial scale are known and are described in common reference works, for example in the article “Hydrogen” in Ullmann's Encyclopedia of Industrial Chemistry, Jun. 15, 2000, DOI: 10.1002/14356007.a13_297, section 4, “Production.” Hydrogen can be produced, for example, from carbon and hydrocarbons in the form of coke oven gas or generally by gasification of gaseous, solid, and liquid carbon sources, such as natural gas, naphtha, or coal. Another way of producing hydrogen from corresponding carbon sources comprises catalytic partial oxidation (PDX) and catalytic reforming in different embodiments, such as steam reforming or autothermal reforming. Combined methods can also be used.

In addition to such synthesis pathways referred to below as “non-electrolytic,” hydrogen can however also be produced electrolytically from water, as explained in the cited article in Ullmann's Encyclopedia of Industrial Chemistry, in particular in section 4.2, “Electrolysis.”

In traditional water electrolysis, an aqueous alkaline solution, typically of potassium hydroxide, is used as the electrolyte (AEL, alkaline electrolysis). Electrolysis with a uni- or bipolar electrode arrangement takes place at atmospheric pressure or on an industrial scale even at a pressure of up to 30 bar. More recent developments in water electrolysis include, for example, the use of proton-conducting ion exchange membranes (PEM, proton exchange membranes), in which the water to be electrolyzed is provided on the anode side. The methods mentioned are so-called low-temperature methods in which the water to be electrolyzed is present in the liquid phase. In addition, so-called steam electrolysis is also carried out, which can likewise be carried out with alkaline electrolytes (i.e., as AEL) with adapted membranes, for example polysulfone membranes, and also using solid oxide electrolysis cells (SOEC) and proton-conducting high-temperature materials. The latter comprise in particular doped zirconium dioxide or doped oxides of other rare earths which become conductive at more than 800° C.

Methods for separating and further processing hydrogen from corresponding methods and for combining electrolytic and non-electrolytic hydrogen production methods are likewise rudimentarily described. For example, WO 2014/172038 A1 discloses a method in which hydrogen is separated electrochemically from a gas mixture formed by reforming and is compressed. In WO 2014/182376 A1, additional hydrogen is obtained from the residual gas of a pressure swing adsorption (PSA) by means of a proton exchange membrane (PEM). In addition, the use of carbon dioxide for an electrochemical production of carbon monoxide is described. Furthermore, WO 2017/144403 A1, for example, proposes electrolyzing carbon dioxide, which is contained in a gas mixture from reforming, to carbon monoxide using a solid oxide electrolysis cell.

Further possibilities for integrating electrolytic and non-electrolytic hydrogen production methods are hardly described in the literature but are basically desirable.

The object of the present invention is therefore to specify an improved method for producing hydrogen, in which in particular the synergy effects of different production methods can be used.

### DISCLOSURE OF THE INVENTION

Against this background, the present invention proposes a method for producing hydrogen and a corresponding plant with the respective features of the independent claims. Preferred embodiments are the subject-matter of the dependent claims and also of the following description.

The present invention proposes combining the production of hydrogen by steam electrolysis with a non-electrolytic method for producing hydrogen.

Overall, the present invention proposes a method for producing hydrogen, in which a carbonaceous feed material is converted to non-electrolytically produced hydrogen and one or more further non-electrolytically produced products in a non-electrolytic process of the type explained above and below. Furthermore, excess steam is provided using the non-electrolytic process.

If mention is made here of the “production of hydrogen” in the non-electrolytic process, this does not exclude that other products, in particular further components of typical synthesis gas, can also be formed there. In this case, a production of hydrogen can therefore always also comprise the production of hydrogen as part of synthesis gas.

The non-electrolytic process can comprise, in particular, steam methane reforming (SMR), optionally also with an import of carbon dioxide upstream or downstream of the reactor, partial oxidation (PDX) or, for example, so-called combined reforming (CR).

In steam methane reforming, in accordance with equation (1), natural gas is reacted with steam to form a hydrogen-rich synthesis gas. In the case of partial oxidation, oxygen is used as is apparent from equation (2). So-called autothermal reforming (ATR) is an internal combination of steam methane reforming and partial oxidation in a reactor. As a result, the advantages of partial oxidation (provision of thermal energy) and steam methane reforming (high hydrogen content) can be combined. Combined reforming in turn combines the two methods of steam methane reforming and autothermal reforming, albeit in two separate units. Combined reforming and autothermal reforming have the advantage that they are very flexible with regard to the hydrogen to carbon monoxide ratio and that the synthesis gas is already provided under elevated pressure.

CH₄+H₂O [symbol] CO+3H₂ΔH⁰_{298K}=206kJ/mol (1)

CH₄+½O₂ [symbol] CO+2H₂ΔH⁰_{298K}=—36kJ/mol (2)

Non-catalytic hydrogen production can basically, albeit with greater formation of carbon monoxide, take place using a method based on carbon dioxide and natural gas, for example so-called dry reforming (DryRef, optionally also with a certain steam fraction, also referred to as bi-reforming). In dry reforming, natural gas with carbon dioxide is converted into a carbon monoxide-rich synthesis gas according to equation (3).

CH₄+CO₂ [symbol] 2CO+2H₂ΔH⁰_{298K}=247kJ/mol (3)

According to the invention, it is provided that at least a part of the excess steam is used at least intermittently for providing feed steam and that the feed steam is converted to electrolytic hydrogen and electrolytic oxygen by means of steam electrolysis.

If mention is made here that “feed steam is converted to electrolytic hydrogen and electrolytic oxygen by means of steam electrolysis,” it is not ruled out, analogously to what has been stated above with regard to the non-electrolytic production of hydrogen, that other products, in particular further electrolysis products, can also be formed in a corresponding steam electrolysis. This is the case in particular when co-electrolysis of steam and carbon dioxide is carried out. In this case, a production of hydrogen can therefore always also comprise the production of carbon monoxide as part of a corresponding product mixture. Here, “steam electrolysis” is intended to mean an electrolysis that is supplied with steam. In principle, in the context of the present invention, steam electrolysis can also be carried out, for example, using proton-conducting membranes, as described, inter alia, in E. Vøllestad et al., “Mixed proton and electron conduction double perovskite anodes for stable and efficient tubular proton ceramic electrolysers,” Nature Materials 18, 2019, pages 752-759.

In traditional water electrolysis, an aqueous alkaline solution, typically of potassium hydroxide, is used as the electrolyte (AEL, alkaline electrolysis; see above). Here, electrolysis with a uni- or bipolar electrode arrangement takes place at atmospheric pressure or on an industrial scale even at a pressure of up to 30 bar. More recent developments in water electrolysis include the use of proton-conducting ion exchange membranes (SPE, solid polymer electrolysis; PEM, proton exchange membranes), in which the water to be electrolyzed is provided on the anode side. The methods mentioned are low-temperature methods in which the water to be electrolyzed is present in the liquid phase. In addition, however, steam electrolysis which is used in the context of the present invention is also carried out, which can likewise be carried out with alkaline electrolytes (i.e., as AEL) with adapted membranes, for example polysulfone membranes, and also using solid oxide electrolysis cells (SOEC). The latter comprise in particular doped zirconium dioxide or oxides of other rare earths which usually become conductive at more than 800° C. Hereinafter, the term “steam electrolysis” is meant to include all of these methods, provided that they are supplied with steam.

High-temperature electrolysis which is carried out using one or more solid oxide electrolysis cells can be used in particular for the electrochemical production of carbon monoxide from carbon dioxide. In this case, oxygen forms on the anode side, and carbon monoxide forms on the cathode side, according to reaction equation (4):

CO₂→CO+½O₂ (4)

The electrochemical production of carbon monoxide from carbon dioxide is described, for example, in WO 2014/154253 A1, WO 201 3/131778 A2, WO 2015/014527 A1, and EP 2 940 773 A1. Where steam is additionally supplied to a corresponding high-temperature electrolysis, it is a co-electrolysis in which hydrogen is formed. This is hence also an electrolytic method for producing hydrogen in the sense of the invention.

The electrochemical production of carbon monoxide from carbon dioxide is also possible by means of low-temperature electrolysis on aqueous electrolytes. In this case, the reactions proceed according to reaction equations (5) and (6):

CO₂+2e⁻+2M⁺+H₂O→CO+2MOH (5)

2MOH→½O₂+2M⁺+2e⁻ (6)

In the case of low-temperature electrolysis, which is optionally still carried out above the evaporation temperature of water, a membrane is used through which the positive charge carriers (M⁺) required according to reaction equation (5) or formed according to reaction equation (6) diffuse from the anode side to the cathode side. In contrast to high-temperature electrolysis, the positive charge carriers here are not transported in the form of oxygen ions but, for example, in the form of positive ions of the electrolyte salt (a metal hydroxide, MOH). An example of a corresponding electrolyte salt may be potassium hydroxide. In this case, the positive charge carriers are potassium ions.

Further embodiments of low-temperature electrolysis include, for example, the use of proton exchange membranes through which protons migrate, or of so-called anion exchange membranes. Different variants are described, for example, in Delacourt et al., J. Electrochem. Soc. 2008, 155, B42-B49, DOI: 10.1149/1.2801871. Hydrogen can be formed here as well.

As mentioned, the non-electrolytic method is operated in such a way that excess steam is provided using said method. Here, “excess steam” is intended to mean a steam amount which is formed in the non-electrolytic method or using the non-electrolytic method by means of heat, for example using burners or waste heat steam generators, but is not consumed in the non-electrolytic method itself, i.e., is converted in particular into hydrogen or used for heating purposes. The former, i.e., the conversion of water to hydrogen, takes place in particular in steam methane reforming or autothermal reforming. In other cases in which water is not used in substance, excess steam is also available from waste heat steam generation.

The present invention proposes in particular the use of a separate steam system which is used for providing the feed steam to steam electrolysis. This is provided in particular to ensure sufficient purity of the feed steam for steam electrolysis. The steam system can be heated in particular using waste heat from the non-electrolytic method, wherein steam can be used as a heat transfer medium or the steam system can be heated directly via heat exchange surfaces. In other words, in the method according to the invention, steam can be provided using the non-electrolytic process or corresponding waste heat and can be used in the further steam system for producing the feed steam. However, it is also possible to heat the further steam system with waste heat of the non-electrolytic process without the use of steam. The formulation according to which the feed steam is provided “using” the excess steam can include that the feed steam is provided as a part of the excess steam but also that only heat of the excess steam is used for the production of the feed steam.

In still other words, the present invention provides for using the excess steam of the conventional non-electrolytic process for steam electrolysis. This results in an increased hydrogen yield. Particularly pure steam can be obtained by means of a separate steam system so that aging of the electrolysis due to poor steam quality can be avoided. The condensate of the unconverted steam from steam electrolysis can, for example, be returned to the non-electrolytic process to obtain steam.

While corresponding steam is often present at high pressure in the aforementioned non-electrolytic processes, it can be expanded for steam electrolysis, in particular when a solid electrolyte electrolysis cell is used. When using alkaline high-pressure electrolysis, however, corresponding steam can also be used at approximately 40 bar. In the context of the present invention, low-pressure steam can also be generated in the non-electrolytic process, wherein the low-pressure steam is advantageously formed at less than 5 bar, in particular more than 2 bar. In this way, the heat from the non-electrolytic process can be utilized better. If necessary, a heat pump can also be used, for example, which brings heat from the non-electrolytic process from below 100° C. to low pressure steam level for steam electrolysis.

In the context of the present invention, the feed steam is used overall at least intermittently in steam electrolysis and is converted into further hydrogen in the process. Because hydrogen is also formed by means of the non-electrolytic method, one particular advantage of the method according to the invention is that part of the hydrogen formed in the non-electrolytic method can be conducted into the steam electrolysis in order to create reducing conditions there. In other words, one embodiment of the invention provides that a part of the non-electrolytically produced hydrogen together with the feed steam is supplied to steam electrolysis at least intermittently. In this way, recycling of hydrogen from the cathode side of the steam electrolysis can be dispensed with. The startup of the steam electrolysis is simplified since hydrogen from the method itself, namely from the non-electrolytic method, can be provided from the beginning, which hydrogen is not yet available from steam electrolysis.

An advantageous embodiment of the present invention comprises a first operating mode and a second operating mode, wherein in the first operating mode, at least the part of the excess steam that is converted by means of steam electrolysis to the electrolytic hydrogen and the electrolytic oxygen is used for providing the feed steam, and wherein in the second operating mode, at least a part of the excess steam is used instead for providing electrical energy, and vice versa. A particular advantage of this embodiment is the possibility to dynamically use the steam of the non-electrolytic process either for generating power in a turbine (at times of high electricity prices and low electricity supply) or for hydrogen production in steam electrolysis (at times of low electricity prices and high electricity supply). The method according to the invention can thus comprise a variable current draw depending on the electricity supply, as is advantageous in particular in connection with the use of renewable energy sources.

As already explained above in connection with steam utilization and described with reference to the respective advantages, in one embodiment of the method, the provision of the feed steam using at least the part of the excess steam can comprise transferring heat of the excess steam or any other heat, in particular waste heat, without material exchange to water or steam of a steam system associated with the steam electrolysis, in which steam system the feed steam is provided for steam electrolysis. In another embodiment, however, the provision of the feed steam using at least the part of the excess steam can also comprise using at least the part of the excess steam as the feed steam, in particular when the excess steam is obtained in a separate steam system from waste heat of the non-electrolytic process.

A particularly advantageous embodiment of the method according to the invention provides that at least a part of the electrolytic hydrogen is used for processing the carbonaceous feed material. In other words, in this embodiment, a utilization of the hydrogen from steam electrolysis is used within the non-electrolytic process or for processing the feed material thereof. Corresponding hydrogen can be used in particular for the desulfurization of the carbonaceous feed material, for example of natural gas. The advantages include, among other things, that a recycle compressor for desulfurization can be dispensed with and that a corresponding non-catalytic process can be started more easily because hydrogen is available from the beginning. Use of the electrolytic hydrogen is advantageous in particular in a shift reaction for reducing the typically copper-containing catalyst during startup.

A further advantageous embodiment of the method according to the invention comprises that at least a part of the electrolytic oxygen is used thermally and/or materially in the non-electrolytic process. Thermal utilization takes place in particular in a burner, for example in steam methane reforming. In this way, the oxygen content can be increased and the required amount of air can be reduced here, thereby improving energy efficiency. Use in a so-called oxyfuel burner in the non-catalytic process or of a secondary burner, in which, for example, combustible gases (purge gases) from the non-catalytic process are combusted, is also possible. The advantage of the latter variant is that especially a secondary burner shows only a comparatively low performance, for example during autothermal reforming, partial oxidation, and a combined reforming method. There, the amount of oxygen produced in the electrolysis is thus sufficient to realize an oxyfuel process (i.e., combustion with oxygen instead of air) without additionally imported oxygen. The oxyfuel process is then particularly efficient. In addition, due to the lack of nitrogen, carbon dioxide can be easily isolated and used for other processes.

In a further embodiment of the method provided according to the invention, the waste heat of the non-electrolytic process can be used for operating the steam electrolysis and/or the waste heat of the steam electrolysis can be used for operating the non-electrolytic process. Reciprocal heat integration is improved in this way. For example, low-temperature waste heat from the non-electrolytic process (at typically less than 100° C.) can be used for heating alkaline solution used in an alkaline electrolysis or for heating other media and components. In this way, depending on the electricity price, the electrolysis can be frequently started and ended and can be quickly brought to operating temperature. Heat utilization in a heat pump can also be used in this context. The waste heat of the steam electrolysis and also of a traditional alkaline electrolysis, which is operated at elevated temperatures (e.g., up to 150° C.) can also be used for steam production or also directly with a heat exchanger, with corresponding steam being able to be operated, for example, for operating the reboiler of an amine scrubbing which is used for separating carbon dioxide from the feed material, for example natural gas, for the non-electrolytic process.

Further embodiments of the present invention include in particular a joint utilization of apparatuses used in the non-electrolytic process and in the steam electrolysis, such as dryers or water treatment devices. Finally, a flue gas can also be formed in the non-electrolytic process, at least a part of the flue gas being used as purge gas in the steam electrolysis.

As mentioned, the invention also extends to a plant for producing hydrogen. The plant is equipped with means which are configured to convert, in a non-electrolytic process, a carbonaceous feed material to non-electrolytically produced hydrogen and one or more further non-electrolytically produced products and to furthermore provide excess steam in the non-electrolytic process.

The plant according to the invention is characterized by means which are configured to at least intermittently use at least a part of the excess steam for providing feed steam and to convert said steam to electrolytic hydrogen and electrolytic oxygen by means of steam electrolysis.

Like the method proposed according to the invention, the plant proposed according to the invention also enables reducing the carbon dioxide footprint of the non-catalytic process and also an easier startup and improved energy efficiency

As regards the features and advantages of the plant proposed according to the invention, reference is made explicitly to the above explanations regarding the method according to the invention and its embodiments. This also applies to a system according to a particularly preferred embodiment of the present invention, which is configured to carry out a method as was explained above in the embodiments thereof.

The invention is explained in more detail hereafter with reference to the accompanying drawings, which illustrate preferred embodiments of the present invention in comparison to the prior art.

### BRIEF DESCRIPTION OF THE DRAWINGS

FIG. 1 illustrates a method not according to the invention.

FIG. 2 illustrates a method according to an embodiment of the invention.

FIG. 3 illustrates a method according to an embodiment of the invention.

### DETAILED DESCRIPTION OF THE DRAWINGS

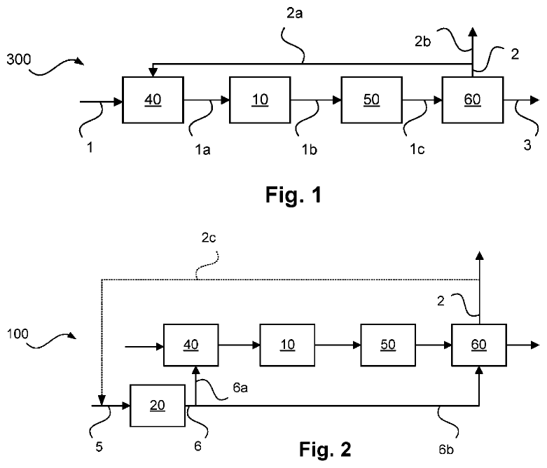

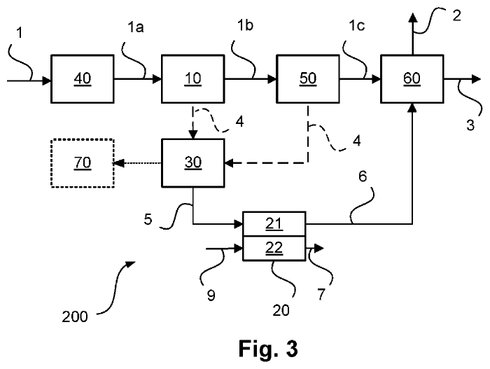

FIG. 1 schematically illustrates a method not according to the invention, whereas FIGS. 2 and 3 show methods according to embodiments of the invention. The explanations apply likewise to corresponding plants. Plant parts or method steps corresponding to one another in structural or functional terms are in each case denoted by identical reference signs and are not explained repeatedly merely for the sake of clarity.

FIG. 1 shows a method not according to the invention for producing hydrogen, which method is denoted as a whole by 300. In method 300, a carbonaceous feed material 1, such as natural gas, is fed to a non-electrolytic process 10, for example a steam methane reforming. In the example illustrated here, the feed material 1 is subjected to a processing 40, for example a desulfurization using hydrogen. The correspondingly processed feed material is denoted by 1a. Further material streams which may be supplied to the non-electrolytic process 10 are not illustrated.

In the non-electrolytic process 10, a product mixture containing hydrogen but in particular also further components, such as carbon monoxide, is obtained and, as illustrated with 1b, is discharged from the non-electrolytic process 10. The product mixture 1b can be subjected, for example, to a heat recovery 50 and, after corresponding cooling, to a hydrogen removal 60 in the form of a material stream 1c. In the hydrogen removal 60, non-electrolytically produced hydrogen is removed in the form of a material stream 2 and, as illustrated here, recycled in a part 2a into the processing 40 of the feed material 1, for example for desulfurization. As illustrated with 2b, further non-electrolytically produced hydrogen can be discharged as product from the method 300. Non-electrolytically formed further products, in particular carbon monoxide, can be discharged in the form of a material stream 3.

The method 100 illustrated in FIG. 2 according to one embodiment of the present invention comprises the method steps 10, 40, 50, and 60 already explained in FIG. 1 for the method 300. In addition, a steam electrolysis 20 is illustrated here, in which feed steam 5 is converted to electrolytic hydrogen 6 and electrolytic oxygen 7 not illustrated separately here but shown only in FIG. 3. The feed steam 5 can be provided from the non-electrolytic process 10 using, in particular, excess steam 4 likewise not illustrated separately here.

As illustrated here, a partial flow, denoted by 6a, of the electrolytic hydrogen 6 from the steam electrolysis 20, like the non-electrolytically provided hydrogen 2a according to FIG. 1, but otherwise for the same purpose, is fed into the processing 40 of the feed material 1. A further portion is conducted, as illustrated with 6b, into the hydrogen removal 60, where the electrolytic hydrogen of the partial stream 6b can be processed as needed together with the non-electrolytically provided hydrogen of material stream 1c. In this way, a joint drying can be used, for example. In this case, the electrolytic hydrogen of the partial stream 6b can be converted to the non-electrolytically provided hydrogen 2.

As illustrated in the form of a dashed material stream 2c, a part of the hydrogen can be recycled to the steam electrolysis 20, for example during startup, for creating reducing conditions.

The method 200 illustrated in FIG. 3 according to one embodiment of the present invention comprises the method steps 10, 40, 50, and 60 already explained in FIG. 1 for method 300 and in FIG. 2 for method 100. In addition, the steam electrolysis 20 is shown here with a cathode side 21 and an anode side 22 and the electrolytic oxygen 7 formed. The anode side 9 can be purged in particular with a purge gas 9 which can be purged from the non-electrolytic process 10 using exhaust gas or flue gas. A flue gas that is sulfur-free is particularly suitable for this purpose. For this purpose, the feed for a corresponding one of the burners is optionally desulfurized with the feed for the process.

FIG. 3 furthermore shows a separate steam system 30 in the method 200, which system, as shown in dashed lines, can be supplied either with excess steam 4 from the non-electrolytic process 10 or from the downstream heat recovery 50 or also only with corresponding heat. In this way, either sufficiently pure feed steam 5 can be provided using the excess steam 4 or corresponding heat.

A supply of steam into the processing 40 is not illustrated separately here, as is not the supply of hydrogen 2c into the steam electrolysis, but it can be provided. The electrolytic oxygen 7 can also be used in the non-electrolytic process 10, either materially or for oxygen-assisted combustion of a fuel.

As illustrated by dashed lines, steam from the steam system, but also, for example, excess steam 4, can also be used, optionally and if necessary, to generate electrical energy in a generator unit 70.

It is understood that all features described in isolation with respect to specific figures or exemplary embodiments can also be used in other exemplary embodiments, alone if described in combination, or in combination if described alone.

1. A method for producing hydrogen, in which, in a non-electrolytic process, a carbonaceous feed material is converted to non-electrolytically produced hydrogen and one or more further non-electrolytically produced products, wherein excess steam is furthermore provided using the non-electrolytic process, wherein at least a part of the excess steam is used at least intermittently to provide feed steam, wherein the feed steam is converted by means of steam electrolysis to electrolytic hydrogen- and electrolytic oxygen.

2. The method according to claim 1, in which the non-electrolytic process comprises reforming in the form of steam methane reforming, partial oxidation, autothermal reforming, combined reforming, or dry reforming, and/or the steam electrolysis comprises a steam electrolysis with alkaline electrolytes, in particular with a polysulfone membrane, a steam electrolysis using a solid oxide electrolysis cell, and/or a high-temperature co-electrolysis with carbon dioxide.

3. The method according to claim 1, in which a part of the non-electrolytically produced hydrogen together with the feed steam is supplied to steam electrolysis at least intermittently.

4. The method according to claim 1, comprising a first operating mode and a second operating mode, wherein in the first operating mode, at least the part of the excess steam that is converted by means of steam electrolysis to the electrolytic hydrogen and the electrolytic oxygen is used for providing the feed steam, and in the second operating mode, at least a part of the excess steam is used for providing electrical energy.

5. The method according to claim 1, in which the provision of the feed steam using at least the part of the excess steam comprises transferring heat of the excess steam or further waste heat without a material exchange to water or steam of a steam system associated with the steam electrolysis, in which steam system the feed steam is provided for steam electrolysis.

6. The method according to claim 1, in which the provision of the feed steam using at least the part of the excess steam comprises using at least the part of the excess steam as the feed steam.

7. The method according to claim 1, in which at least a part of the electrolytic hydrogen is used for processing the carbonaceous feed material.

8. The method according to claim 1, in which at least a part of the electrolytic hydrogen is used for reducing a shift catalyst.

9. The method according to claim 1, in which at least a part of the electrolytic oxygen is used thermally and/or materially in the non-electrolytic process.

10. The method according to claim 1, in which waste heat of the non-electrolytic process is used for operating the steam electrolysis and/or waste heat of the steam electrolysis is used for operating the non-electrolytic process.

11. The method according to claim 1, in which apparatuses used in the non-electrolytic process and in the steam electrolysis are used together.

12. The method according to claim 1, in which a flue gas is formed in the non-electrolytic process, wherein at least a part of the flue gas is used as purge gas in the steam electrolysis.

13. A plant for producing hydrogen, with means configured to convert, in a non-electrolytic process, a carbonaceous feed material to non-electrolytically produced hydrogen and one or more further non-electrolytically produced products and to furthermore provide excess steam using the non-electrolytic process, wherein means configured to use at least a part of the excess steam at least intermittently for providing feed steam and to convert the feed steam to electrolytic hydrogen and electrolytic oxygen by means of steam electrolysis.

14. The plant according to claim 13, which is configured to carry out a method a method for producing hydrogen, in which, in a non-electrolytic process, a carbonaceous feed material is converted to non-electrolytically produced hydrogen and one or more further non-electrolytically produced products, wherein excess steam is furthermore provided using the non-electrolytic process, wherein at least a part of the excess steam is used at least intermittently to provide feed steam, wherein the feed steam is converted by means of steam electrolysis to electrolytic hydrogen and electrolytic oxygen.
